(19) United States
(12) Patent Application Publication
(10) Pub. No.: US 2006/0152749 A1
(43) Pub. Date: Jul. 13, 2006

(54) Terminal device for printing a message displayed on messenger window and a method therefor

(75) Inventors: Myoung-Jin Oh, Suwon-si (KR); Seung-Wan Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/325,422

(22) Filed: Jan. 5, 2006

(30) Foreign Application Priority Data
Jan. 7, 2005 (KR) 2005-01814

(51) Int. Cl. G06F 3/12

(52) U.S. Cl. 358/1.13

(57) ABSTRACT

A terminal device displays a messenger window by executing a messenger program. The terminal device includes a messenger window generation unit for generating and displaying a messenger window on a screen by executing a predetermined messenger program, a printing option setting unit for displaying a printing option setting menu for setting printing options of conversation messages displayed on the messenger window, an editing unit for editing the conversation messages according to the printing option set through the printing option setting menu, and a printer driver unit for converting the edited conversation messages to a print file interpretable by a predetermined printer and transmitting the print file to the printer. Accordingly, the conversation messages can be edited and printed through the messenger window.

### CROSS-REFERENCE TO RELATED APPLICATIONS

This application claims the benefit under 35 U.S.C. § 119(a) of Korean Patent Application No. 2005-1814, filed Jan. 7, 2005, the entire contents of which are hereby incorporated by reference.

### BACKGROUND OF THE INVENTION

1. Field of the Invention

The present invention relates to a terminal device capable of printing messages being displayed on a messenger window, and a method for the same. More particularly, the present invention relates to a terminal device that allows a user to edit and print messages being displayed on a messenger window by installing and executing a plug-in program.

2. Description of the Related Art

As high-speed internet service becomes more prevalent, the number of internet users has significantly increased. One of the most frequently used programs on the internet is a messenger program that enables a plurality of users to communicate messages and data real-time with one another. Various messenger programs which are currently widely used are available from portal sites such as ICQ, AOL, MSN, Genie, Daum and Buddybuddy, and other messenger programs are provided by other portal sites.

By downloading and executing a messenger program, a user can hold on-line conversations. More specifically, after executing a messenger program, a user logs in by inputting a user identification (ID) and a password and selects a conversation partner by inputting an e-mail address or an ID of the conversation partner. The messenger program displays a messenger window showing conversation messages with the selected partner, on part of a screen.

When the user wants to print the conversation on paper with a printer, the whole conversation can be transmitted to a printer driver program by selecting a print menu provided by the messenger window. The printer driver program converts the whole conversation to a predetermined print language interpretable by the printer, and transmits the print language to the printer.

The user may, however, want to print out just a part of the conversation instead of the whole conversation. For example, a user may wish to print out messages associated with a specific ID. Furthermore, even when printing out the whole conversation, the user may want to edit the conversation messages with different fonts, colors, or sizes according to each ID to distinguish the conversation messages for easy recognition. However, since an editing function is not provided by the messenger program of a conventional terminal device, a user has to save the whole conversation as a word processor file, for example, and then open and edit the whole conversation.

Accordingly, there is a need for an improved terminal device which is capable of editing and printing conversation messages using a messenger program.

### SUMMARY OF THE INVENTION

An aspect of the present invention is to address at least the above problems and/or disadvantages and to provide at least the advantages described below. Accordingly, an aspect of the present invention is to provide a terminal device that is capable of editing and printing conversation messages directly on a messenger window by executing a plug-in program every time that the messenger program is executed, and a method for doing the same.

In accordance with an aspect of the present invention, a terminal device comprising a messenger window generation unit, a printing option setting unit, an editing unit, and a printer driver unit is provided. The messenger window generation unit generates and displays a messenger window on a screen by executing a predetermined messenger program. The printing option setting unit displays a printing option setting menu for setting printing options of conversation messages displayed on the messenger window. The editing unit edits the conversation messages according to the printing options set through the printing option setting menu. The printer driver unit converts the edited conversation messages to a print file interpretable by a printer and transmits the print file to the printer.

The printing option setting unit displays the printing option setting menu on a part of the messenger window by executing a plug-in program for adding the printing option setting menu to the messenger window every time that the messenger program is executed.

When the plug-in program is determined to be uninstalled when executing the messenger program, the printing option setting unit generates and displays a pop-up window inquiring whether to install the plug-in program on the screen.

When the plug-in program is determined to have been updated when executing the messenger program, the printing option setting unit generates and displays a pop-up window inquiring whether to install the updated plug-in program on the screen.

When the printing option setting menu is selected, the printing option setting unit generates and displays on the screen a user interface window for selecting one of first, second and third editing modes. The first editing mode displays conversation messages of only a designated ID, the second editing mode displays conversation messages of the messenger window according to the ID, and the third editing mode displays the whole conversation.

The terminal device may further comprise a memory unit for storing information on at least one of size, font, color, shadow, and text style set according to the ID, set through the messenger window. When the second editing mode is selected, the editing unit converts and displays the conversation messages of each ID that are displayed on the messenger window, according to the information stored in the memory unit.

In accordance with another aspect of the present invention, a method for printing a messenger window in a terminal device connected to an external printer is provided. The method comprises the steps of (a) generating a messenger window by executing a predetermined messenger program and displaying the messenger program on a screen, (b) displaying a printing option setting menu on a part of the messenger window to set printing options of conversation messages being displayed on the messenger window, (c) when a predetermined printing option is set through the printing option setting menu, editing the conversation messages according to the set printing options, and (d) converting the edited conversation messages to a print file interpretable by the printer and transmitting the print file to the printer.

The step (b) of displaying a printing option setting menu on a part of the messenger window may be accomplished by executing a predetermined plug-in program for adding the printing option setting menu to the messenger window, every time that the messenger program is executed.

The method may further comprise generating and displaying a pop-up window inquiring whether to install the plug-in program on the screen when the plug-in program is determined to be uninstalled when executing the messenger program.

The method may further comprise generating and displaying a pop-up window inquiring whether to install an updated plug-in program on the screen when the plug-in program is determined to have been updated when executing the messenger program.

The step (c) may comprise, when the printing option setting menu is selected, generating and displaying on the screen a user interface window for selecting one of first, second and third editing modes. The first editing mode displays conversation messages of only a designated ID, the second editing mode displays conversation messages according to the ID, and the third editing mode displays the whole conversation. When a predetermined editing mode is selected through the user interface window, the conversation messages on the messenger window are edited according to the selected mode.

The step (c) may comprise storing information on at least one of size, font, color, shadow, and text style set according to the ID of the messenger window, and when the second editing mode is selected, converting the conversation messages of each ID being displayed on the messenger window, according to the stored information.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a block diagram of the structure of a terminal device according to an exemplary embodiment of the present invention;

FIG. 2 is a diagram of an exemplary structure of a messenger window displayed on a screen of the terminal device of FIG. 1;

FIGS. 3A and 3B are diagrams of an exemplary structure of a user interface window for setting printing options with respect to conversation messages displayed through the messenger window;

FIGS. 4A and 4B are diagrams of the conversation messages displayed through the messenger window, as edited according to the set printing options; and

FIG. 5 is a flowchart of a method for printing out the messenger window of the terminal device according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

An exemplary embodiment of the present invention will now be described in detail with reference to the accompanying drawing figures.

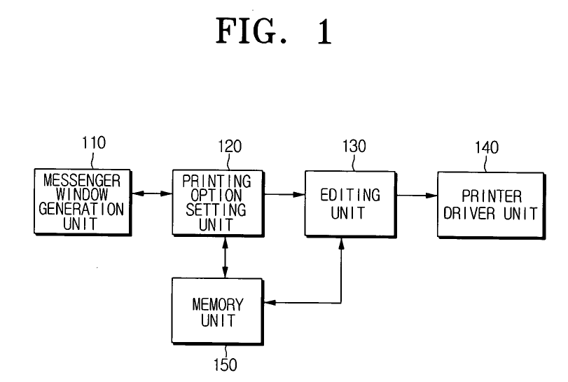

Referring to FIG. 1, a block diagram of the structure of a terminal device according to an exemplary embodiment of the present invention, the terminal device comprises a messenger window generation unit 110, a printing option setting unit 120, an editing unit 130, a printer driver unit 140, and a memory unit 150. The terminal device may be any device capable of installing and executing a messenger program, such as a desktop personal computer (PC), a notebook PC, a personal digital assistant (PDA), a mobile phone, and the like.

The messenger window generation unit 110 comprises an organization module which, when a predetermined messenger program is installed and executed by a user, generates and displays on a screen a messenger window. The messenger window comprises a conversation window showing conversation messages, a message window showing a message to be transmitted by the present user, and a printing menu for printing out the conversation messages. These will be described in greater detail hereinafter.

The printing option setting unit 120 comprises an organization module for adding a printing option setting menu on a part of the messenger window by executing a predetermined plug-in program. The plug-in program refers to a subprogram operated in a certain program in order to supplement functions of the certain program. The plug-in program executed by the printing option setting unit 120 of the terminal device further provides a function of setting printing options, which is not supplied by the messenger program. Such a plug-in program may be stored in the memory unit 150 of the terminal device or may be downloaded from a particular site.

When it is determined that the plug-in program is not installed, the printing option setting unit 120 displays a pop-up window inquiring whether to install the plug-in program when the user executes the messenger program. If the user selects installation of the plug-in program, the plug-in program is automatically installed and, once installed, the plug-in program is automatically executed every time that the messenger program is executed. Accordingly, the printing option setting unit 120 controls the messenger window generation unit 110 so as to further display the printing option setting menu on a part of the messenger window.

The editing unit 130 comprises an organization module for editing conversation messages displayed on the messenger window according to operation modes set by the user through the printing option setting menu. The details of the printing option setting menu and the corresponding editing operations will be described more specifically hereinafter.

The printer driver unit 140 converts the conversation messages edited through the editing unit 130 to a print file formed with a print language interpretable by an external printer and transmits the print file to the printer. In this case, the terminal device and the external printer may be connected through a serial interface such as a universal serial bus (USB), a general parallel interface, or any other suitable interface known to those skilled in the art. The print language can be determined according to the type of external printer being used. For example, more specifically, the print language may be the Printer Control Language (PCL) of the Hewlett Packard Company or the PostScript language of Adobe Systems Incorporated.

The memory unit 150 stores information on the printing options preset by the user. Therefore, upon input of a printing command by the user through the messenger window, the editing unit 130 edits the conversation messages displayed on the messenger window according to the printing options stored in the memory unit 150 and transmits the edited conversation messages to the printer driver unit 140.

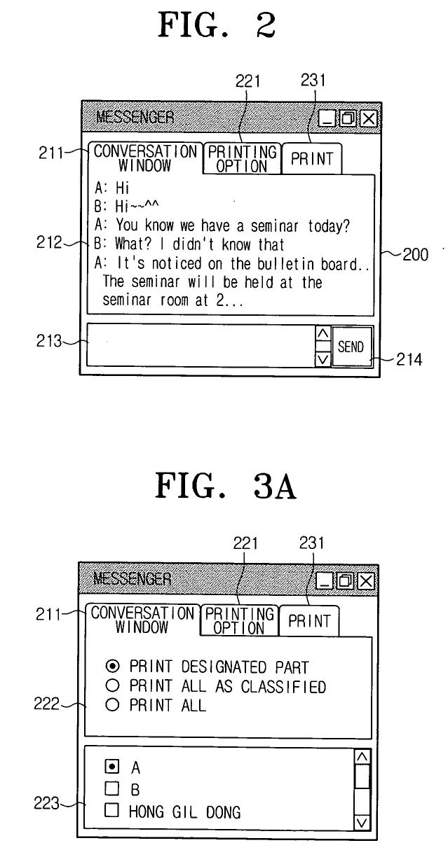

FIG. 2 shows an example of a messenger window 200 generated by the messenger program. Referring to FIG. 2, the messenger window 200 comprises a conversation window menu 211 for displaying a conversation window 212, a printing option setting menu 221 for setting printing options, and a printing menu 231 for inputting the printing command. A mouse or a keyboard may be used to select each menu 211, 221, and 231.

A lower part of the conversation window 212 displays a message window 213 for showing the message being presently input, and a send menu 214. The user can transmit a desired message by writing the message on the message window 213 and then selecting the send menu 214. The transmitted message is displayed on the conversation window 212.

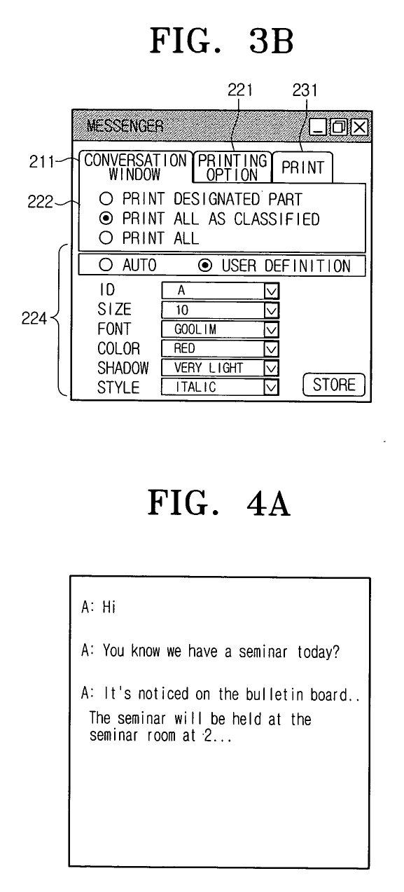

FIG. 3A shows the messenger window 200 of FIG. 2 in a state that the printing option setting menu 221 is selected. According to FIG. 3A, when the printing option setting menu 221 is selected, a first user interface window 222 is displayed to enable the user to select an editing mode. The editing mode displayed on the first user interface window 222 comprises “print designated part,” “print all as classified,” and “print all.”

When the “print designated part” is selected, a second user interface window 223 is displayed below the first user interface window 222 to let the user designate a specific ID. Upon designation of the specific ID and selection of the printing menu 231, conversation messages of only the designated ID is extracted. Here, a plurality of IDs can be designated.

FIG. 3B shows the messenger window 200 when the “print all as classified” menu is selected from the first user interface window 222. Referring to FIG. 3B, various menus for setting display modes for the conversation messages of each ID are displayed below the first user interface window 222. More specifically, for example, an “auto” menu for setting the display modes as a predetermined default value and a “user definition” menu for setting the display modes according to the user's selection are provided. Upon selection of the “user definition” menu, the various menus for setting the display modes such as ID, size, font, color, shadow, and text style are displayed. By setting each menu and selecting a storage button, the display modes for each ID can be set. When the printing menu 231 is selected in this state, the whole conversation on the messenger window 200 is displayed as classified according to the ID.

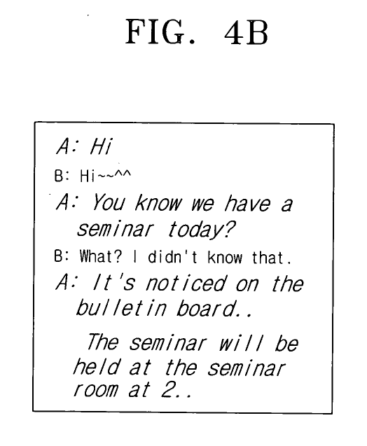

FIG. 4A shows the conversation messages as edited when only a part of the IDs are designated as shown in FIG. 3A. For example, when an ID “A” is designated from the messenger window 200 of FIG. 2, the conversation messages of only the ID “A” are printed.

FIG. 4B shows the conversation messages as edited when the “print all as classified” menu is selected as shown in FIG. 3B. Referring to FIG. 4B, the conversation messages of the ID “A” and the conversation messages of an ID “B” are edited and printed to be distinguishable from each other.

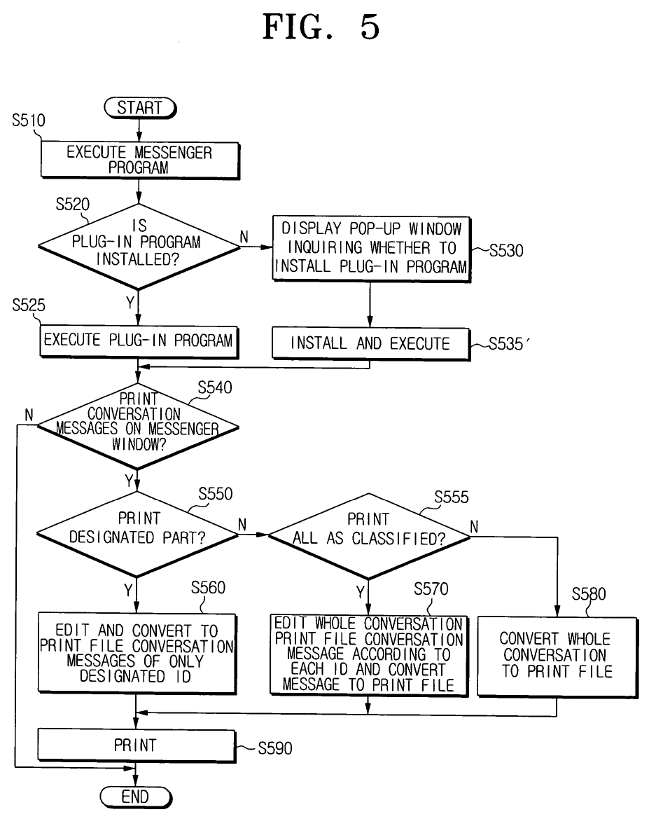

FIG. 5 is a flowchart of a method for printing the messenger window of the terminal device, according to an exemplary embodiment of the present invention. Referring to FIG. 5, when the messenger program is executed (S510), it is determined whether the plug-in program is installed (S520).

If the plug-in program is determined to have been installed, the plug-in program is executed so that the printing option setting menu is displayed on a part of the messenger window (S525).

If the plug-in program is determined to have not been installed, a pop-up window inquiring whether to install the plug-in program is displayed (S530).

When the user selects installation of the plug-in program, the plug-in program is automatically installed and executed, thereby displaying the printing option setting menu on a part of the messenger window (S535).

Next, when the user wants to print the conversation messages being displayed on the messenger window (S540), the editing mode selected through the printing option setting menu is checked. When the editing mode is the “print designated part” (S550), the conversation messages of only the designated ID are edited and converted to the print language (S560).

When the editing mode is “print all as classified” (S555), the whole conversation is edited to be distinguishable according to the ID and converted to the print language (S570).

When the editing mode is neither the “print designated part” nor the “print all as classified” (S550 and S555), the whole conversation is converted to the print language (S580).

Accordingly, the print file as converted is transmitted to the printer and printed out (S590). As a result, the conversation messages edited by the user can be directly printed.

As can be appreciated from the above description of an exemplary embodiment of the present invention, the conversation messages can be edited directly through the messenger window by executing the plug-in program. Accordingly, the inconvenience of saving and editing the conversation messages with a separate program is avoided. In addition, user convenience is improved through the functions of partial editing and printing according to the IDs.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A terminal device comprising:
a messenger window generation unit for generating and displaying a messenger window on a screen by executing a predetermined messenger program;
a printing option setting unit for displaying a printing option setting menu for setting printing options of conversation messages displayed on the messenger window;
an editing unit for editing the conversation messages according to the printing option set through the printing option setting menu; and
a printer driver unit for converting the edited conversation messages to a print file interpretable by a predetermined printer and transmitting the print file to the printer.

2. The terminal device of claim 1, wherein
the printing option setting unit displays the printing option setting menu on a part of the messenger window by executing a plug-in program for adding the printing option setting menu to the messenger window.

3. The terminal device of claim 2, wherein
when the plug-in program is determined to have not been installed when executing the messenger program, the printing option setting unit generates and displays a pop-up window inquiring whether to install the plug-in program on the screen.

4. The terminal device of claim 3, wherein
when the plug-in program is determined to have been updated when executing the messenger program, the printing option setting unit generates and displays a pop-up window inquiring whether to install the updated plug-in program on the screen.

5. The terminal device of claim 4, wherein
when the printing option setting menu is selected, the printing option setting unit generates and displays on the screen a user interface window for selecting one of first, second and third editing modes, the first editing mode for displaying conversation messages of only a designated ID, the second editing mode for displaying conversation messages of the messenger window according to the ID, and the third editing mode for displaying the whole conversation.

6. The terminal device of claim 5, further comprising
a memory unit for storing information on at least one of size, font, color, shadow, and text style set according to the ID, set through the messenger window.

7. The terminal device of claim 6, wherein
when the second editing mode is selected, the editing unit converts and displays the conversation messages of each ID, being displayed on the messenger window, according to the information stored in the memory unit.

8. A method for printing a messenger window in a terminal device connected to an external printer, comprising the steps of:
(a) generating a messenger window by executing a predetermined messenger program and displaying the messenger program on a screen;
(b) displaying a printing option setting menu on a part of the messenger window to set printing options of conversation messages being displayed on the messenger window;
(c) when a predetermined printing option is set through the printing option setting menu, editing the conversation messages according to the set printing options; and
(d) converting the edited conversation messages to a print file interpretable by the printer and transmitting the print file to the printer.

9. The method of claim 8, wherein
the step (b) of displaying the printing option setting menu on a part of the messenger window is accomplished by executing a predetermined plug-in program for adding the printing option setting menu to the messenger window.

10. The method of claim 9, further comprising the step of
generating and displaying a pop-up window inquiring whether to install the plug-in program on the screen when the plug-in program is determined to have not been installed when executing the messenger program.

11. The method of claim 10, further comprising the step of
generating and displaying a pop-up window inquiring whether to install an updated plug-in program on the screen when the plug-in program is determined to have been updated when executing the messenger program.

12. The method of claim 10, wherein the step (c) comprises:
when the printing option setting menu is selected, generating and displaying on the screen a user interface window for selecting one of first, second and third editing modes, the first editing mode for displaying conversation messages of only a designated ID, the second editing mode for displaying conversation messages according to the ID, and the third editing mode for displaying the whole conversation; and
when a predetermined editing mode is selected through the user interface window, editing the conversation messages on the messenger window according to the selected mode.

13. The method of claim 12, wherein the step (c) comprises:
storing information on at least one of size, font, color, shadow, and text style set according to the ID of the messenger window, and
when the second editing mode is selected, converting the conversation messages of each ID, being displayed on the messenger window, according to the stored information.

14. A computer-readable medium having computer-executable instructions for a method of printing a messenger window in a terminal device connected to an external printer, the method comprising the steps of:
(a) generating a messenger window by executing a predetermined messenger program and displaying the messenger program on a screen;
(b) displaying a printing option setting menu on a part of the messenger window to set printing options of conversation messages being displayed on the messenger window;
(c) when a predetermined printing option is set through the printing option setting menu, editing the conversation messages according to the set printing options; and
(d) converting the edited conversation messages to a print file interpretable by the printer and transmitting the print file to the printer.

15. The computer readable medium of claim 14, wherein
the step (b) of displaying the printing option setting menu on a part of the messenger window is accomplished by executing a predetermined plug-in program for adding the printing option setting menu to the messenger window.

16. The computer readable medium of claim 15, further comprising computer-executable instructions for performing the step of:
generating and displaying a pop-up window inquiring whether to install the plug-in program on the screen when the plug-in program is determined to have not been installed when executing the messenger program.

17. The computer readable medium of claim 16, further comprising computer-executable instructions for performing the step of:
generating and displaying a pop-up window inquiring whether to install an updated plug-in program on the screen when the plug-in program is determined to have been updated when executing the messenger program.

18. The computer readable medium of claim 16, wherein the step (c) comprises:
when the printing option setting menu is selected, generating and displaying on the screen a user interface window for selecting one of first, second and third editing modes, the first editing mode for displaying conversation messages of only a designated ID, the second editing mode for displaying conversation messages according to the ID, and the third editing mode for displaying the whole conversation; and
when a predetermined editing mode is selected through the user interface window, editing the conversation messages on the messenger window according to the selected mode.

19. The computer readable medium of claim 18, wherein the step (c) comprises:
storing information on at least one of size, font, color, shadow, and text style set according to the ID of the messenger window, and
when the second editing mode is selected, converting the conversation messages of each ID, being displayed on the messenger window, according to the stored information.
